(19) United States
(12) Patent Application Publication
(10) Pub. No.: US 2024/0242369 A1
(43) Pub. Date: Jul. 18, 2024

(54) Fast Point Cloud Registration for Bootstrapping Localization in a Map

(71) Applicant: FORD GLOBAL TECHNOLOGIES, LLC, Dearborn, MI (US)

(72) Inventors: Eric WESTMAN, Pittsburgh, PA (US); Kunal Desai, Pittsburgh, PA (US)

(73) Assignee: FORD GLOBAL TECHNOLOGIES, LLC, Dearborn, MI (US)

(21) Appl. No.: 18/097,013

(22) Filed: Jan. 13, 2023

(51) Int. Cl. G06T 7/70; G01S 17/89; G06T 5/40; G06T 17/05; G06V 10/44; G06V 10/74

(52) U.S. Cl. CPC G06T 7/70; G01S 17/89; G06T 5/40; G06T 17/05; G06V 10/44; G06V 10/761

(57) ABSTRACT

Disclosed herein are system, method, and computer program product embodiments for fast point cloud registration for bootstrapping localization in a high-definition (HD) map. A computing device in an autonomous vehicle (AV) derives a query point cloud from a sweep of a light detection and ranging (lidar) sensor device of the AV and a reference point cloud from an HD map. The computing device extracts a first set of features from the query point cloud and a second set of features from the reference point cloud. The computing device calculates a coarse alignment based on a plurality of matches between the first set of features from the query point cloud and the second set of features from the reference point cloud. Finally, the computing device estimates the position-orientation pose of the vehicle by refining the coarse alignment using an iterative closest point (ICP) algorithm.

### BACKGROUND

Autonomous vehicles (AVs) can be configured to operate autonomously and navigate their environment with little or no human input. In order to do so safely, AVs may use high-definition (HD) maps in combination with various sensors that collect real-time data about roadways, surrounding vehicles, and other objects or actors that they may encounter. HD maps are highly precise roadmaps comprising two map layers: a point cloud map layer that contains three-dimensional geometric information of surroundings and a semantic feature map layer that contains information about lane boundaries, lane stops, intersections, pedestrian crossings, stop signs, traffic signs, and the like. Upon the commencement of an activation sequence of the vehicle, an AV may use the data in HD maps to assist with localization.

Development and implementation of accurate and robust localization processes continues to be a significant challenge in the field of autonomous vehicles. Previous solutions for localizing an AV include a bootstrap process that aligns a point cloud from sensor data (e.g., GPS sensors, lidar sensors, etc.) to a point cloud obtained from an HD map using an Iterative Closest Point (ICP) algorithm. In order to converge to an accurate position-orientation pose, ICP requires a good initial estimate of the alignment between the two point clouds. During the bootstrap process, the only initial estimate of the vehicle's alignment with a map of its surroundings is derived from a GPS measurement. However, because GPS measurements are routinely inaccurate (e.g., off by multiple meters), the bootstrap process may result in point cloud registration inaccuracies.

One approach to obtain an accurate point cloud registration during a bootstrap process relies on running an ICP algorithm multiple times using different sampled “seed” poses as initial alignment estimates. Heuristic metrics are then used to determine which ICP solution, if any, is correct. This procedure is unfortunately also slow and error-prone. Accordingly, what is needed are improved approaches for performing point cloud registration to determine an AV's position and orientation relative to an HD map.

### SUMMARY

Aspects disclosed herein generally relate to methods, systems, and computer program products for fast point cloud registration for bootstrapping localization in a high-definition (HD) map. The method can include deriving, by one or more computing devices, a query point cloud from a sweep of a light detection and ranging (lidar) sensor device of a vehicle and a reference point cloud from a HD map. The method can further include extracting, by the one or more computing devices, a first set of features from the query point cloud and a second set of features from the reference point cloud. The method can further include determining, by the one or more computing devices, a coarse alignment based on a plurality of matches between the first set of features from the query point cloud and the second set of features from the reference point cloud. Finally, the method can include estimating a position-orientation pose of the vehicle by refining the coarse alignment using an iterative closest point (ICP) algorithm.

### BRIEF DESCRIPTION OF THE DRAWINGS

The accompanying drawings are incorporated herein and form a part of the specification.

FIG. 1 illustrates an exemplary autonomous vehicle system, in accordance with aspects of the disclosure.

FIG. 2 illustrates an exemplary architecture for a vehicle, in accordance with aspects of the disclosure.

FIG. 3 illustrates an exemplary architecture for a Light Detection and Ranging (“lidar”) system, in accordance with aspects of the disclosure.

FIG. 4 illustrates a flow chart of an example method for estimating a position-orientation pose of a vehicle using fast point cloud registration for bootstrapping localization in a map, in accordance with aspects of the disclosure.

FIG. 5 illustrates a flow chart of an example method for deriving a reference point cloud from an HD map, in accordance with aspects of the disclosure.

FIG. 6 illustrates a flow chart of an example method for determining a coarse alignment between a query point cloud and a reference point cloud, in accordance with aspects of the disclosure.

FIG. 7 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for fast point cloud registration for bootstrapping localization in a high-definition (HD) map.

Autonomous vehicles (AVs) can be configured to operate autonomously and navigate their environment with little or no human input. AVs use an array of sensors to collect real-time data about their environment such as roadways, surrounding vehicles, and other objects or actors that they may encounter during a trip. One or more machine learning algorithms in AVs make driving decisions based on the real-time data. Although sensors such as light detection and ranging (lidar) and cameras alert AVs to actors or objects in their path, their utility is limited to only what is visible at any given moment. Accordingly, in order to operate safely in their environment, AVs also use HD maps. HD maps are highly precise and data rich roadmaps. HD maps may contain two map layers: a point-cloud map layer comprising three-dimensional geometric information of surroundings and a semantic feature map layer comprising data regarding lane boundaries, lane stops, intersections, pedestrian crossings, stop signs, traffic signs, and the like. HD maps may also be partitioned into a plurality of map tiles, and each map tile may contain a predefined geographical area. AVs use the data in HD maps to assist with localization upon startup and to accurately navigate on a lane-level basis.

Localization is the task of determining an AV's position-orientation pose relative to its position in an HD map. Localization is critically important to the operation of AV because the vehicle must first precisely identify its location and orientation with respect to its surroundings in order to navigate its environment using the semantic feature map data in the HD map. Localization involves computing the point cloud registration of a first point cloud obtained from real-time sensor data of an AV (e.g., GPS sensors, lidar sensors, etc.) to a second point cloud obtained from an HD map. Point cloud registration (or more specifically, rigid registration) further involves calculating the transformation (e.g., rotation and translation) necessary to align the first point cloud to the second point cloud.

Accurate and robust localization continues to be a significant challenge. Previous solutions include a bootstrap process that uses an Iterative Closest Point (ICP) algorithm to align a first point cloud derived from sensor data of an AV to a second point cloud obtained from an HD map. Although an ICP algorithm can compute the rigid registration of two point clouds in scenarios where there is a good initial alignment between the first and second point clouds, the algorithm fails when the initial alignment is poor and/or partially inaccurate. During a bootstrap process, the only initial estimate of the AV's alignment with respect to a map of its surroundings is a GPS measurement. However, GPS-based measurements are routinely off by multiple meters and provide no indication of the orientation of the vehicle.

One approach to aligning a first point cloud derived from sensor data of an AV to a second point cloud obtained from an HD map during a bootstrap process relies on running an ICP algorithm multiple times using different sampled “seed” poses as initial alignment estimates. Thereafter, heuristic metrics are used to determine which ICP solution, if any, is correct. However, this procedure is also slow (e.g., regularly taking 30-60 seconds to complete) and error-prone (e.g., often failing to converge on an accurate aligned position-orientation pose solution). Accordingly, what is needed are improved approaches for performing point cloud registration to determine an AV's position and orientation relative to an HD map.

Aspects described herein provide an improved method and system for fast point cloud registration for bootstrapping localization in a HD map. The disclosed method and system address the aforementioned technological problem of point cloud registration inaccuracies during a bootstrap process. Furthermore, the disclosed method and system are ideal in scenarios where GPS sensors are used to provide an initial estimate of an AV's alignment relative to a map of its surroundings. According to the disclosed method and system, one or more computing devices in an AV may select, based on geolocation data acquired from one or more geolocation sensor devices of the vehicle, a map tile comprising a predefined geographical area that includes an initial location of the vehicle from a plurality of map tiles in an HD map. The one or more computing devices in the AV may derive a reference point cloud from the selected map tile in the HD map and a query point cloud from a sweep of light detection and ranging (lidar) sensor device of a vehicle. The one or more computing devices in the AV may extract a first set of features from the query point cloud and a second set of features from the reference point cloud. The one or more computing devices in the AV may determine a coarse alignment based on a plurality of matches between the first set of features from the query point cloud and the second set of features from the reference point cloud. Finally, the one or more computing devices in the AV may estimate a position-orientation pose of the vehicle by refining the coarse alignment using an ICP algorithm.

The term “vehicle” refers to any moving form of conveyance that is capable of carrying either one or more human occupants and/or cargo and is powered by any form of energy. The term “vehicle” includes, but is not limited to, cars, trucks, vans, trains, autonomous vehicles, aircraft, aerial drones and the like. An “autonomous vehicle” (or “AV”) is a vehicle having a processor, programming instructions and drivetrain components that are controllable by the processor without requiring a human operator. An autonomous vehicle may be fully autonomous in that it does not require a human operator for most or all driving conditions and functions, or it may be semi-autonomous in that a human operator may be required in certain conditions or for certain operations, or that a human operator may override the vehicle's autonomous system and may take control of the vehicle.

Notably, the present solution is being described herein in the context of an autonomous vehicle. However, the present solution is not limited to autonomous vehicle applications. The present solution may be used in other applications such as robotic applications, radar system applications, metric applications, and/or system performance applications.

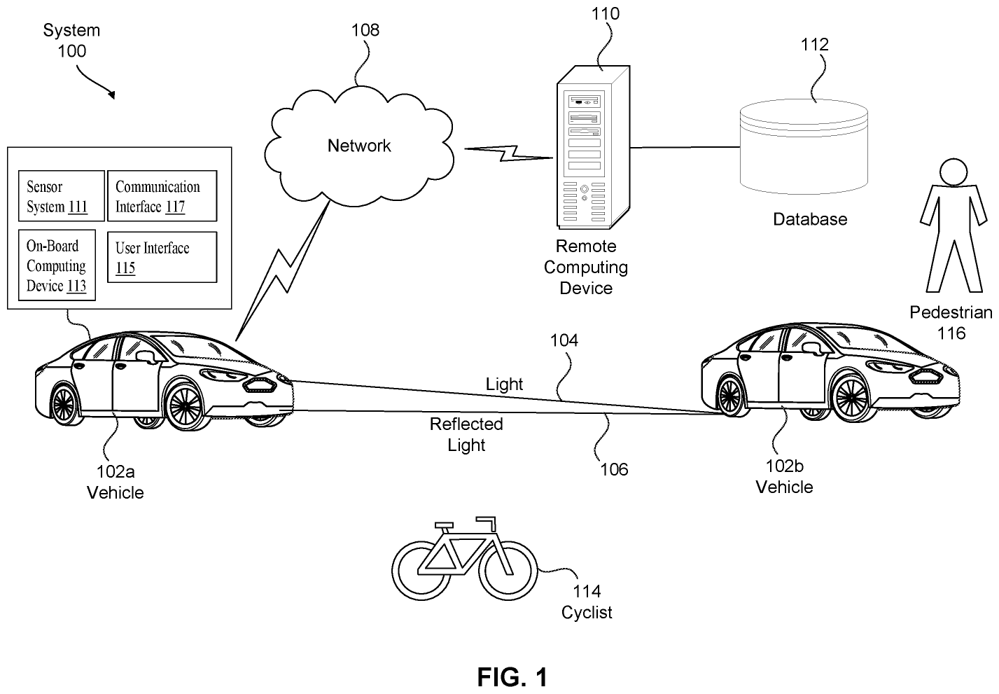

FIG. 1 illustrates an exemplary autonomous vehicle system 100, in accordance with aspects of the disclosure. System 100 comprises a vehicle 102a that is traveling along a road in a semi-autonomous or autonomous manner. Vehicle 102a is also referred to herein as AV 102a. AV 102a can include, but is not limited to, a land vehicle (as shown in FIG. 1), an aircraft, or a watercraft.

AV 102a is generally configured to detect objects 102b, 114, 116 in proximity thereto. The objects can include, but are not limited to, a vehicle 102b, cyclist 114 (such as a rider of a bicycle, electric scooter, motorcycle, or the like) and/or a pedestrian 116.

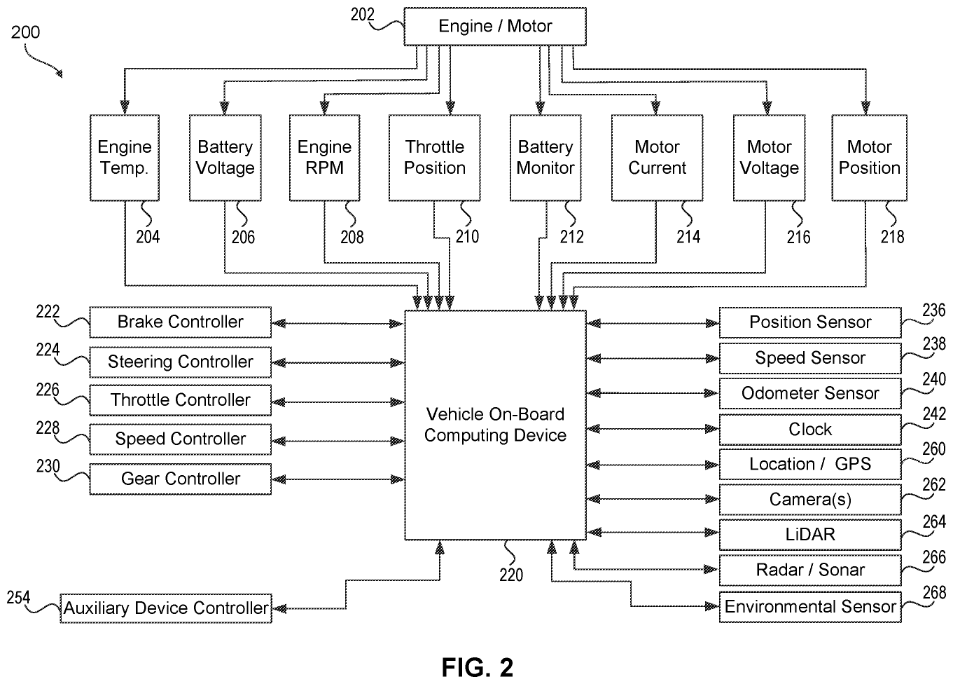

As illustrated in FIG. 1, the AV 102a may include a sensor system 111, an on-board computing device 113, a communications interface 117, and a user interface 115. Autonomous vehicle 101 may further include certain components (as illustrated, for example, in FIG. 2) included in vehicles, which may be controlled by the on-board computing device 113 using a variety of communication signals and/or commands, such as, for example, acceleration signals or commands, deceleration signals or commands, steering signals or commands, braking signals or commands, etc.

The sensor system 111 may include one or more sensors that are coupled to and/or are included within the AV 102a, as illustrated in FIG. 2. For example, such sensors may include, without limitation, a lidar system, a radio detection and ranging (RADAR) system, a laser detection and ranging (LADAR) system, a sound navigation and ranging (SONAR) system, one or more cameras (e.g., visible spectrum cameras, infrared cameras, etc.), temperature sensors, position sensors (e.g., global positioning system (GPS), etc.), location sensors, fuel sensors, motion sensors (e.g., inertial measurement units (IMU), etc.), humidity sensors, occupancy sensors, or the like. The sensor data can include information that describes the location of objects within the surrounding environment of the AV 102a, information about the environment itself, information about the motion of the AV 102a, information about a route of the vehicle, or the like. As AV 102a travels over a surface, at least some of the sensors may collect data pertaining to the surface.

As will be described in greater detail, AV 102a may be configured with a lidar system, e.g., lidar system 264 of FIG. 2. The lidar system may be configured to transmit a light pulse 104 to detect objects located within a distance or range of distances of AV 102a. Light pulse 104 may be incident on one or more objects (e.g., AV 102b) and be reflected back to the lidar system. Reflected light pulse 106 incident on the lidar system may be processed to determine a distance of that object to AV 102a. The reflected light pulse may be detected using, in some embodiments, a photodetector or array of photodetectors positioned and configured to receive the light reflected back into the lidar system. Lidar information, such as detected object data, is communicated from the lidar system to an on-board computing device, e.g., on-board computing device 220 of FIG. 2. The AV 102a may also communicate lidar data to a remote computing device 110 (e.g., cloud processing system) over communications network 108. Remote computing device 110 may be configured with one or more servers to process one or more processes of the technology described herein. Remote computing device 110 may also be configured to communicate data/instructions to/from AV 102a over network 108, to/from server(s) and/or database(s) 112.

It should be noted that the lidar systems for collecting data pertaining to the surface may be included in systems other than the AV 102a such as, without limitation, other vehicles (autonomous or driven), robots, satellites, etc.

Network 108 may include one or more wired or wireless networks. For example, the network 108 may include a cellular network (e.g., a long-term evolution (LTE) network, a code division multiple access (CDMA) network, a 3G network, a 4G network, a 5G network, another type of next generation network, etc.). The network may also include a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, and/or the like, and/or a combination of these or other types of networks.

AV 102a may retrieve, receive, display, and edit information generated from a local application or delivered via network 108 from database 112. Database 112 may be configured to store and supply raw data, indexed data, structured data, map data, program instructions or other configurations as is known.

The communications interface 117 may be configured to allow communication between AV 102a and external systems, such as, for example, external devices, sensors, other vehicles, servers, data stores, databases etc. The communications interface 117 may utilize any now or hereafter known protocols, protection schemes, encodings, formats, packaging, etc. such as, without limitation, Wi-Fi, an infrared link, Bluetooth, etc. The user interface system 115 may be part of peripheral devices implemented within the AV 102a including, for example, a keyboard, a touch screen display device, a microphone, and a speaker, etc.

FIG. 2 illustrates an exemplary system architecture 200 for a vehicle, in accordance with aspects of the disclosure. Vehicles 102a and/or 102b of FIG. 1 can have the same or similar system architecture as that shown in FIG. 2. Thus, the following discussion of system architecture 200 is sufficient for understanding vehicle(s) 102a, 102b of FIG. 1. However, other types of vehicles are considered within the scope of the technology described herein and may contain more or less elements as described in association with FIG. 2. As a non-limiting example, an airborne vehicle may exclude brake or gear controllers, but may include an altitude sensor. In another non-limiting example, a water-based vehicle may include a depth sensor. One skilled in the art will appreciate that other propulsion systems, sensors and controllers may be included based on a type of vehicle, as is known.

As shown in FIG. 2, system architecture 200 includes an engine or motor 202 and various sensors 204-218 for measuring various parameters of the vehicle. In gas-powered or hybrid vehicles having a fuel-powered engine, the sensors may include, for example, an engine temperature sensor 204, a battery voltage sensor 206, an engine Rotations Per Minute (“RPM”) sensor 208, and a throttle position sensor 210. If the vehicle is an electric or hybrid vehicle, then the vehicle may have an electric motor, and accordingly includes sensors such as a battery monitoring system 212 (to measure current, voltage and/or temperature of the battery), motor current 214 and voltage 216 sensors, and motor position sensors 218 such as resolvers and encoders.

Operational parameter sensors that are common to both types of vehicles include, for example: a position sensor 236 such as an accelerometer, gyroscope and/or inertial measurement unit; a speed sensor 238; and an odometer sensor 240. The vehicle also may have a clock 242 that the system uses to determine vehicle time during operation. The clock 242 may be encoded into the vehicle on-board computing device, it may be a separate device, or multiple clocks may be available.

The vehicle also includes various sensors that operate to gather information about the environment in which the vehicle is traveling. These sensors may include, for example: a location sensor 260 (e.g., a Global Positioning System (“GPS”) device); object detection sensors such as one or more cameras 262; a lidar system 264; and/or a radar and/or a sonar system 266. The sensors also may include environmental sensors 268 such as a precipitation sensor and/or ambient temperature sensor. The object detection sensors may enable the vehicle to detect objects that are within a given distance range of the vehicle 200 in any direction, while the environmental sensors collect data about environmental conditions within the vehicle's area of travel.

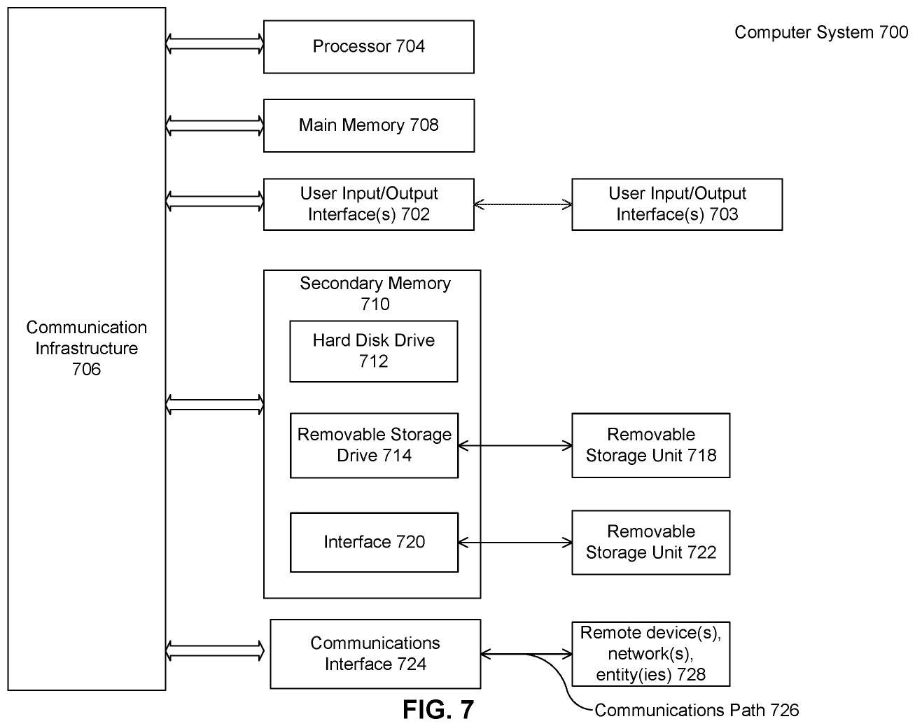

During operations, information is communicated from the sensors to a vehicle on-board computing device 220. The on-board computing device 220 may be implemented using the computer system of FIG. 7. The vehicle on-board computing device 220 analyzes the data captured by the sensors and optionally controls operations of the vehicle based on results of the analysis. For example, the vehicle on-board computing device 220 may control: braking via a brake controller 222; direction via a steering controller 224; speed and acceleration via a throttle controller 226 (in a gas-powered vehicle) or a motor speed controller 228 (such as a current level controller in an electric vehicle); a differential gear controller 230 (in vehicles with transmissions); and/or other controllers. Auxiliary device controller 254 may be configured to control one or more auxiliary devices, such as testing systems, auxiliary sensors, mobile devices transported by the vehicle, etc.

Geographic location information may be communicated from the location sensor 260 to the on-board computing device 220, which may then access a map of the environment that corresponds to the location information to determine known fixed features of the environment such as streets, buildings, stop signs and/or stop/go signals. Captured images from the cameras 262 and/or object detection information captured from sensors such as lidar system 264 is communicated from those sensors) to the on-board computing device 220. The object detection information and/or captured images are processed by the on-board computing device 220 to detect objects in proximity to the vehicle 200. Any known or to be known technique for making an object detection based on sensor data and/or captured images can be used in the embodiments disclosed in this document.

Lidar information is communicated from lidar system 264 to the on-board computing device 220. Additionally, captured images are communicated from the camera(s) 262 to the vehicle on-board computing device 220. The lidar information and/or captured images are processed by the vehicle on-board computing device 220 to detect objects in proximity to the vehicle 200. The manner in which the object detections are made by the vehicle on-board computing device 220 includes such capabilities detailed in this disclosure.

The on-board computing device 220 may include and/or may be in communication with a routing controller 231 that generates a navigation route from a start position to a destination position for an autonomous vehicle. The routing controller 231 may access a map data store to identify possible routes and road segments that a vehicle can travel on to get from the start position to the destination position. The routing controller 231 may score the possible routes and identify a preferred route to reach the destination. For example, the routing controller 231 may generate a navigation route that minimizes Euclidean distance traveled or other cost function during the route, and may further access the traffic information and/or estimates that can affect an amount of time it will take to travel on a particular route. Depending on implementation, the routing controller 231 may generate one or more routes using various routing methods, such as Dijkstra's algorithm, Bellman-Ford algorithm, or other algorithms. The routing controller 231 may also use the traffic information to generate a navigation route that reflects expected conditions of the route (e.g., current day of the week or current time of day, etc.), such that a route generated for travel during rush-hour may differ from a route generated for travel late at night. The routing controller 231 may also generate more than one navigation route to a destination and send more than one of these navigation routes to a user for selection by the user from among various possible routes.

In various embodiments, the on-board computing device 220 may determine perception information of the surrounding environment of the AV 102a. Based on the sensor data provided by one or more sensors and location information that is obtained, the on-board computing device 220 may determine perception information of the surrounding environment of the AV 102a. The perception information may represent what an ordinary driver would perceive in the surrounding environment of a vehicle. The perception data may include information relating to one or more objects in the environment of the AV 102a. For example, the on-board computing device 220 may process sensor data (e.g., lidar or RADAR data, camera images, etc.) in order to identify objects and/or features in the environment of AV 102a. The objects may include traffic signals, road way boundaries, other vehicles, pedestrians, and/or obstacles, etc. The on-board computing device 220 may use any now or hereafter known object recognition algorithms, video tracking algorithms, and computer vision algorithms (e.g., track objects frame-to-frame iteratively over a number of time periods) to determine the perception.

In some embodiments, the on-board computing device 220 may also determine, for one or more identified objects in the environment, the current state of the object. The state information may include, without limitation, for each object: current location; current speed and/or acceleration, current heading; current pose; current shape, size, or footprint; type (e.g., vehicle vs. pedestrian vs. bicycle vs. static object or obstacle); and/or other state information.

The on-board computing device 220 may perform one or more prediction and/or forecasting operations. For example, the on-board computing device 220 may predict future locations, trajectories, and/or actions of one or more objects. For example, the on-board computing device 220 may predict the future locations, trajectories, and/or actions of the objects based at least in part on perception information (e.g., the state data for each object comprising an estimated shape and pose determined as discussed below), location information, sensor data, and/or any other data that describes the past and/or current state of the objects, the AV 102a, the surrounding environment, and/or their relationship(s). For example, if an object is a vehicle and the current driving environment includes an intersection, the on-board computing device 220 may predict whether the object will likely move straight forward or make a turn. If the perception data indicates that the intersection has no traffic light, the on-board computing device 220 may also predict whether the vehicle may have to fully stop prior to enter the intersection.

In various embodiments, the on-board computing device 220 may determine a motion plan for the autonomous vehicle. For example, the on-board computing device 220 may determine a motion plan for the autonomous vehicle based on the perception data and/or the prediction data. Specifically, given predictions about the future locations of proximate objects and other perception data, the on-board computing device 220 can determine a motion plan for the AV 102a that best navigates the autonomous vehicle relative to the objects at their future locations.

In some embodiments, the on-board computing device 220 may receive predictions and make a decision regarding how to handle objects and/or actors in the environment of the AV 102a. For example, for a particular actor (e.g., a vehicle with a given speed, direction, turning angle, etc.), the on-board computing device 220 decides whether to overtake, yield, stop, and/or pass based on, for example, traffic conditions, map data, state of the autonomous vehicle, etc. Furthermore, the on-board computing device 220 also plans a path for the AV 102a to travel on a given route, as well as driving parameters (e.g., distance, speed, and/or turning angle). That is, for a given object, the on-board computing device 220 decides what to do with the object and determines how to do it. For example, for a given object, the on-board computing device 220 may decide to pass the object and may determine whether to pass on the left side or right side of the object (including motion parameters such as speed). The on-board computing device 220 may also assess the risk of a collision between a detected object and the AV 102a. If the risk exceeds an acceptable threshold, it may determine whether the collision can be avoided if the autonomous vehicle follows a defined vehicle trajectory and/or implements one or more dynamically generated emergency maneuvers is performed in a pre-defined time period (e.g., N milliseconds). If the collision can be avoided, then the on-board computing device 220 may execute one or more control instructions to perform a cautious maneuver (e.g., mildly slow down, accelerate, change lane, or swerve). In contrast, if the collision cannot be avoided, then the on-board computing device 220 may execute one or more control instructions for execution of an emergency maneuver (e.g., brake and/or change direction of travel).

As discussed above, planning and control data regarding the movement of the autonomous vehicle is generated for execution. The on-board computing device 220 may, for example, control braking via a brake controller; direction via a steering controller; speed and acceleration via a throttle controller (in a gas-powered vehicle) or a motor speed controller (such as a current level controller in an electric vehicle); a differential gear controller (in vehicles with transmissions); and/or other controllers.

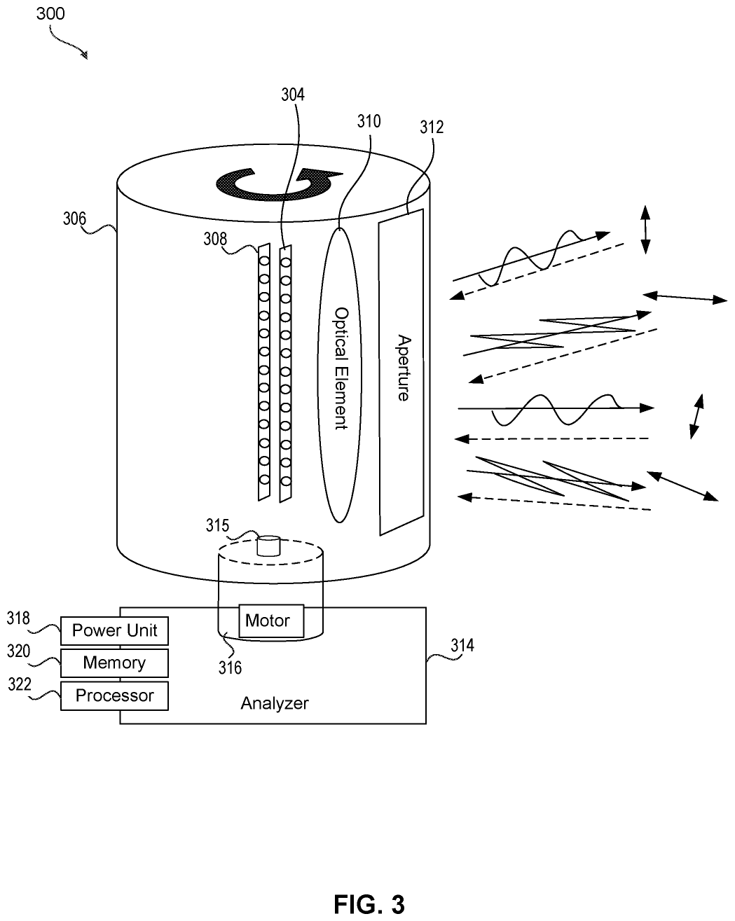

FIG. 3 illustrates an exemplary architecture for a lidar system 300, in accordance with aspects of the disclosure. Lidar system 264 of FIG. 2 may be the same as or substantially similar to the lidar system 300. As such, the discussion of lidar system 300 is sufficient for understanding lidar system 264 of FIG. 2. It should be noted that the lidar system 300 of FIG. 3 is merely an example lidar system and that other lidar systems are further completed in accordance with aspects of the present disclosure, as should be understood by those of ordinary skill in the art.

As shown in FIG. 3, the lidar system 300 includes a housing 306 which may be rotatable 360° about a central axis such as hub or axle 315 of motor 316. The housing may include an emitter/receiver aperture 312 made of a material transparent to light. Although a single aperture is shown in FIG. 3, the present solution is not limited in this regard. In other scenarios, multiple apertures for emitting and/or receiving light may be provided. Either way, the lidar system 300 can emit light through one or more of the aperture(s) 312 and receive reflected light back toward one or more of the aperture(s) 312 as the housing 306 rotates around the internal components. In an alternative scenario, the outer shell of housing 306 may be a stationary dome, at least partially made of a material that is transparent to light, with rotatable components inside of the housing 306.

Inside the rotating shell or stationary dome is a light emitter system 304 that is configured and positioned to generate and emit pulses of light through the aperture 312 or through the transparent dome of the housing 306 via one or more laser emitter chips or other light emitting devices. The light emitter system 304 may include any number of individual emitters (e.g., 8 emitters, 64 emitters, or 128 emitters). The emitters may emit light of substantially the same intensity or of varying intensities. The lidar system also includes a light detector 308 containing a photodetector or array of photodetectors positioned and configured to receive light reflected back into the system. The light emitter system 304 and light detector 308 would rotate with the rotating shell, or they would rotate inside the stationary dome of the housing 306. One or more optical element structures 310 may be positioned in front of the light emitter system 304 and/or the light detector 308 to serve as one or more lenses or waveplates that focus and direct light that is passed through the optical element structure 310.

One or more optical element structures 310 may be positioned in front of a mirror (not shown) to focus and direct light that is passed through the optical element structure 310. As shown below, the system includes an optical element structure 310 positioned in front of the mirror and connected to the rotating elements of the system so that the optical element structure 310 rotates with the mirror. Alternatively or in addition, the optical element structure 310 may include multiple such structures (for example lenses and/or waveplates). Optionally, multiple optical element structures 310 may be arranged in an array on or integral with the shell portion of the housing 306.

Lidar system 300 includes a power unit 318 to power the light emitting unit 304, a motor 316, and electronic components. Lidar system 300 also includes an analyzer 314 with elements such as a processor 322 and non-transitory computer-readable memory 320 containing programming instructions that are configured to enable the system to receive data collected by the light detector unit, analyze it to measure characteristics of the light received, and generate information that a connected system can use to make decisions about operating in an environment from which the data was collected. Optionally, the analyzer 314 may be integral with the lidar system 300 as shown, or some or all of it may be external to the lidar system and communicatively connected to the lidar system via a wired or wireless communication network or link.

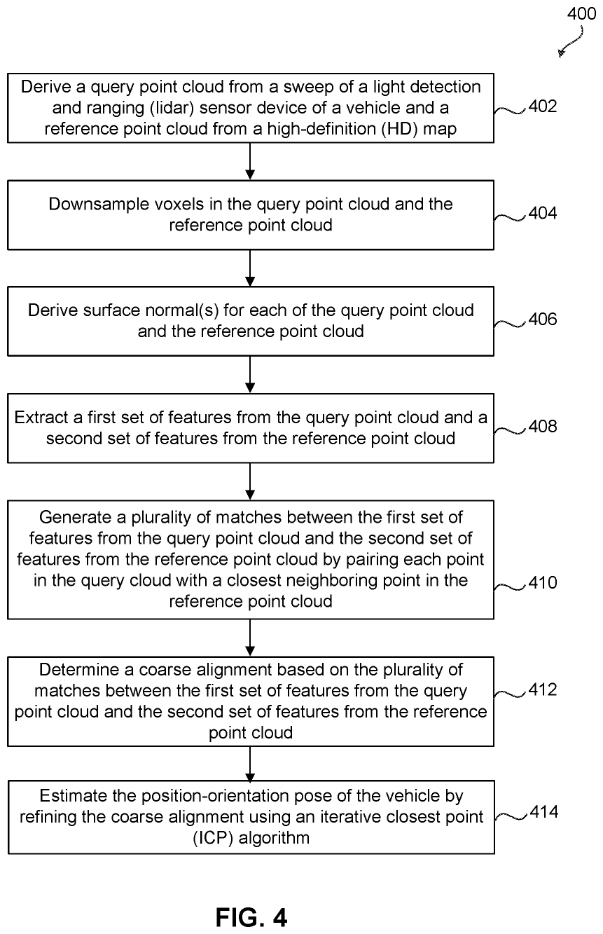

FIG. 4 illustrates a flow chart of an example method 400 for estimating a position-orientation pose of a vehicle using fast point cloud registration for bootstrapping localization in a map, in accordance with aspects of the disclosure. In some embodiments, the various steps of method 400 may be performed by a localization module of the on-board computing device 220 described in FIG. 2. Furthermore, the localization module may be implemented as software, hardware, or a combination of software and hardware.

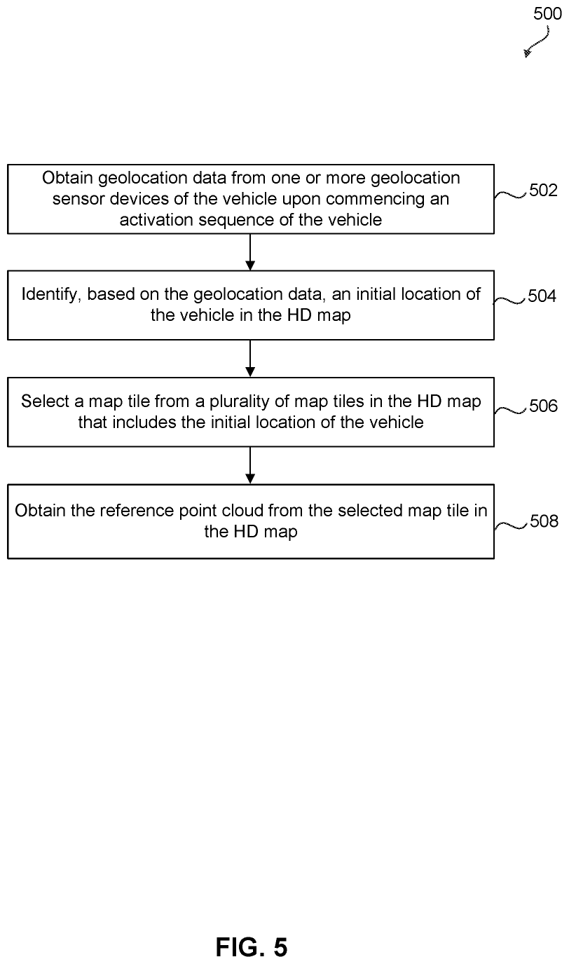

The method 400 may begin with block 402, which may include deriving a query point cloud from a sweep of a light detection and ranging sensor device of a vehicle and a reference point cloud from an HD map. In some embodiments, deriving a query point cloud from a sweep of a lidar sensor may include the localization module obtaining a point cloud from a single sweep by the lidar system 264 described in FIG. 2. Query point clouds obtained by lidar sensors may reflect a specific view of the vehicle's surroundings and include sparse representations of objects in that view. In some embodiments, deriving a reference point cloud from an HD map may include the localization module obtaining a point cloud from the point cloud map layer of an HD map. Unlike query point clouds, reference point clouds are usually dense and may be created by aggregating multiple lidar sensor sweeps from various views. The method for deriving a reference point cloud from an HD map is described in further detail at FIG. 5.

Block 404 of method 400 may include downsampling the query point cloud and the reference point cloud. The number of points in the query point cloud and reference point cloud derived in block 402 can be quite large and challenging to process. In order to improve computational efficiency, the query point cloud and the reference point cloud may be downsampled by a selecting a representative subset of points from each point cloud. In some embodiments, downsampling the query point cloud and the reference point cloud may include the localization module partitioning both point clouds into grids of equally-spaced and non-overlapping voxels (i.e., small three-dimensional boxes). Afterwards, the localization module may reduce the number of points in each point cloud by approximating the points in each voxel with their centroid and selecting the centroid as the point to be included in the representative subset of points.

Block 406 of method 400 may include deriving a surface normal for each point in the query point cloud and the reference point cloud. A surface normal at a given point in a point cloud is a vector that is perpendicular to the tangential plane at that point on the surface of the object depicted in the point cloud. Surface normals are important because they help determine an object's surface characteristics such as its orientation and rate of change of curvature. In some embodiments, deriving a surface normal for each point in the query point cloud and the reference point cloud may include the localization module using a Principal Component Analysis method. For example, the localization module may analyze the eigenvectors and eigenvalues of a covariance matrix for a given point that is created using its nearest neighbors. The localization module may further create a covariance matrix for each point in a point cloud as follows:

$$\text{?} = \frac{1}{k} \text{?} ( {p}_{i} - \overline{p} ) \cdot {( {p}_{i} - \overline{p} )}^{T} \text{?} = \text{?} j ∈ \{ 0 , 1 , 2 \} \qquad ( 1 )$$

$$\text{?} \text{indicates text missing or illegible when filed}$$

Where k is the number of point neighbors considered in the neighborhood of pᵢ, p̅ is the 3D centroid of the nearest neighbors, λⱼ is the j-th eigenvalue of the covariance matrix, and v̅ⱼ̅ is the j-th eigenvector of the covariance matrix.

Block 408 of method 400 may include extracting a first set of features from the query point cloud and a second set of features from the reference point cloud. In some embodiments, the first and second sets of features to be extracted are local descriptors that provide geometric information about their respective point clouds and assist with generating effective correspondences between the query point cloud and the reference point cloud.

One example of local feature descriptors are point feature histograms. Point feature histograms are pose-invariant local features that represent the underlying surface model properties at a point, p, in the point cloud. Point feature histograms for a point cloud may be generated by: (i) estimating multi-value features for each point based on a combination of geometrical properties of nearby points in that point's k-neighborhood; and (ii) creating feature descriptions by binning the multi-value features into a histogram. Although point feature histograms are informative, generating them for a particularly dense point cloud (e.g., a reference point cloud from an HD map) can represent one of the major bottlenecks in point cloud registration due to its high computational complexity. Fast point feature histograms have since been proposed for use in real-time and near real-time applications. As a simplified version of point feature histograms, fast point feature histograms greatly reduce the computational complexity of extracting features from a point cloud.

Accordingly, in at least one embodiment, the localization module may extract a first set of features from the query point cloud and a second set of features from the reference point cloud by computing fast point feature histograms for both point clouds. The localization module may calculate fast point feature histograms for the query point cloud and the reference point cloud by initially computing a simplified point feature histogram for each point, p, in the point clouds. A simplified point feature histogram may comprise a set of three angular features (α, Φ, and θ) that characterize the difference between a pair of points (pᵢ and pⱼ) in the k-neighborhood of point p and their associated surface normals (nᵢ and nⱼ). The simplified point feature histogram may also include a fourth feature that represents the Euclidian distance (δ) between the pair of points (pᵢ and pⱼ). The simplified point feature histogram may be calculated as follows:

$$α = v * {n}_{j} \qquad ( 2 )$$

$$Φ = \frac{( u * ( {p}_{j} - {p}_{i} ) )}{δ}$$

$$θ = arctan ( w * {n}_{j} , u * {n}_{j} )$$

$$Where u = {n}_{i} , v = ( {p}_{j} - {p}_{i} ) * u , w = u * v , and δ = {‖ {p}_{j} - {p}_{i} ‖}_{2}$$

After calculating the simplified point feature histogram for every point in the query point cloud and reference point cloud, the localization module may further compute the fast point feature histogram for every point in the two point clouds. The fast point feature histogram for a point p may be obtained by re-determining its k neighbors and using the simplified point feature histogram values of neighboring points to weight the final histogram as follows:

$$FPFH ( p ) = SPF ( p ) + \frac{1}{k} {\sum }_{i = 1}^{k} \frac{1}{{ω}_{k}} \cdot SPF ( {p}_{k} ) \qquad ( 3 )$$

Where the weight wₖ represents the distance between the point, p, and a neighboring point, pₖ, in a given metric space.

Block 410 of method 400 may include generating a plurality of matches between the first set of features from the query point cloud and the second set of features from the reference point cloud. In some embodiments, generating a plurality of matches between the first and second set of features may include the localization module identifying, for each point in the query point cloud, its closest neighboring point in the feature space of the reference point cloud and creating a pairing between the two points. Moreover, because every point in the query point cloud is ultimately paired to another point in the reference point cloud, it is anticipated that this one-way pairing process may produce a large number of matches.

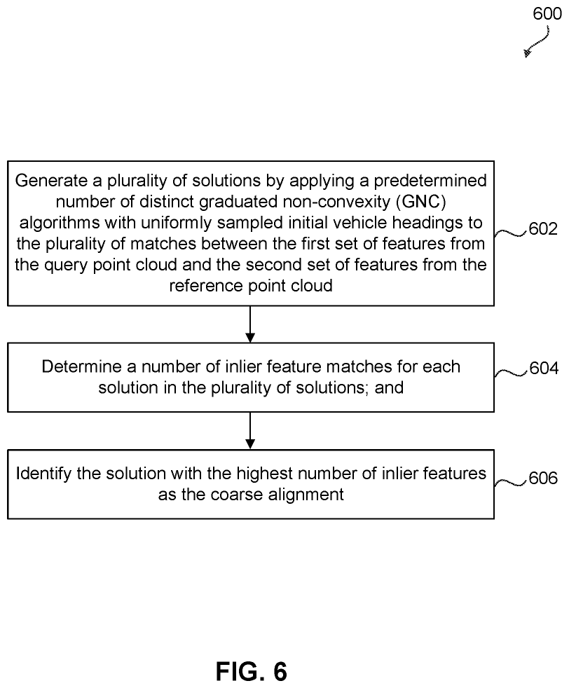

Block 412 of method 400 may include determining a coarse alignment based on the plurality of matches between the first set of features from the query point cloud and the second set of features from the reference point cloud. In some embodiments, the localization module may generate a coarse alignment based on the plurality of matches using a graduated non-convexity optimization. A graduated non-convexity optimization is a nonlinear optimization that utilizes a robust cost function with a control parameter u. Starting with a high value of u results in a more convex objective function and makes it more likely that the optimization will converge to a solution near a true global minimum. Iteratively reducing the value of u gradually transforms the initial objective function into the “target” objective function with no artificial convexity added. When applied to point cloud registration problems, the graduated non-convexity optimization enables the computation of a rigid registration between two point clouds without the need to provide an initial estimate of alignment or update correspondences between the point clouds. The method for generating a coarse alignment is described in further detail at FIG. 6.

Finally, block 414 of method 400 may include the localization module estimating the correct position-orientation pose of the vehicle by refining the coarse alignment using an ICP algorithm.

FIG. 5 illustrates a flow chart of an example method 500 for deriving a reference point cloud from an HD map, in accordance with aspects of the disclosure. In some embodiments, the various steps of method 500 may be performed by a localization module of the on-board computing device 220 described in FIG. 2.

Block 502 of method 500 may include obtaining geolocation data from one or more geolocation sensor devices of the vehicle at the commencement of an activation sequence of the vehicle. In some embodiments, the localization module may receive GPS data from a GPS sensor in the AV upon vehicle ignition. In other embodiments, the localization module may alternatively obtain GPS data from a GPS sensor in the AV whenever the vehicle requires a new position-orientation pose.

Block 504 of method 500 may include identifying, based on the geolocation data, an initial location of the vehicle in the HD map. In some embodiments, the localization module may first access an HD map previously stored in the AV or download one from an HD map server. HD maps often use a standard coordinate system and are geospatially synchronized with the one or more geolocation sensor devices of an AV. After accessing an HD map, the localization module may further determine an initial location of the AV in the HD map using the GPS data obtained in block 502.

Block 506 of method 500 may include selecting a map tile from a plurality of map tiles in the HD map that includes the initial location of the vehicle. As described earlier, HD maps may be partitioned into a plurality of map tiles, wherein each map tile contains a defined geographical area. In some embodiments, the localization module may identify the map tile in the HD map that includes the initial location of the AV.

Finally, block 508 of method 500 may include obtaining the reference point cloud from the selected map tile in the HD map. In some embodiments, the localization module may obtain the reference point cloud from the point cloud map layer of the map tile selected in block 506.

FIG. 6 illustrates a flow chart of an example method for determining a coarse alignment between a query point cloud and a reference point cloud, in accordance with aspects of the disclosure. In some embodiments, the various steps of method 600 may be performed by a localization module of the on-board computing device 220 described in FIG. 2.

Block 602 of method 600 may include generating a plurality of transformation solutions by applying a predetermined number of graduated non-convexity optimizations with uniformly sampled initial vehicle headings to the plurality of matches between the first set of features from the query point cloud and the second set of features from the reference point cloud. In some embodiments, the localization module may first identify a set of vehicle headings (or directions). Identifying a set of vehicle headings is necessary because the highly robust graduated non-convexity optimization may still not converge to the correct transformation solution given that (a) the overwhelming majority of the feature matches in the plurality of matches generated at block 410 are outliers and (b) an initial alignment estimate may be up to 180 degrees off in the vehicle's heading. In at least one embodiment, the localization module may identify eight vehicle headings that are each separated by 45 degree increments. The localization module may further generate a plurality of transformation solutions by performing eight distinct graduated non-convexity optimizations with the identified vehicle headings.

Block 604 of method 600 may include determining a number of inlier feature matches for each transformation solution in the plurality of transformation solutions. In some embodiments, an inlier feature match is a feature correspondence pair comprising a first point in the query point cloud that is within a predetermined distance of a second point in the reference point cloud according to the transformation solution. In at least one embodiment, the localization module may calculate, for each transformation solution, the number of inlier feature matches having a first point in the query point cloud that is within three meters of a second point in the reference point cloud.

Block 606 of method 600 may include identifying the transformation solution with the highest number of inlier feature matches. In some embodiments, the localization module may select the transformation solution with the highest number of inlier feature matches as the coarse alignment. Afterwards, the localization module may estimate the correct position-orientation pose of the vehicle by refining the coarse alignment using an ICP algorithm.

Although FIGS. 4, 5, and 6 depict steps that are performed in a particular order for purposes of illustration and discussion, the methods of the present disclosure are not limited to the illustrated order or arrangement. The various steps of methods 400, 500, and 600 can be omitted, rearranged, combined, and/or adapted in various ways without deviating from the scope of the present disclosure.

Various embodiments can be implemented, for example, using one or more computer systems, such as computer system 700 shown in FIG. 7. Computer system 700 can be any computer capable of performing the functions described herein.

Computer system 700 includes one or more processors (also called central processing units, or CPUs), such as a processor 704. Processor 704 is connected to a communication infrastructure or bus 706.

One or more processors 704 may each be a graphics processing unit (GPU). In an embodiment, a GPU is a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 700 also includes user input/output device(s) 703, such as monitors, keyboards, pointing devices, etc., that communicate with communication infrastructure 706 through user input/output interface(s) 702.

Computer system 700 also includes a main or primary memory 708, such as random access memory (RAM). Main memory 708 may include one or more levels of cache. Main memory 708 has stored therein control logic (i.e., computer software) and/or data.

Computer system 700 may also include one or more secondary storage devices or memory 710. Secondary memory 710 may include, for example, a hard disk drive 712 and/or a removable storage device or drive 714. Removable storage drive 714 may be a floppy disk drive, a magnetic tape drive, a compact disk drive, an optical storage device, tape backup device, and/or any other storage device/drive.

Removable storage drive 714 may interact with a removable storage unit 718. Removable storage unit 718 includes a computer usable or readable storage device having stored thereon computer software (control logic) and/or data. Removable storage unit 718 may be a floppy disk, magnetic tape, compact disk, DVD, optical storage disk, and/any other computer data storage device. Removable storage drive 714 reads from and/or writes to removable storage unit 718 in a well-known manner.

According to an exemplary embodiment, secondary memory 710 may include other means, instrumentalities or other approaches for allowing computer programs and/or other instructions and/or data to be accessed by computer system 700. Such means, instrumentalities or other approaches may include, for example, a removable storage unit 722 and an interface 720. Examples of the removable storage unit 722 and the interface 720 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 700 may further include a communication or network interface 724. Communication interface 724 enables computer system 700 to communicate and interact with any combination of remote devices, remote networks, remote entities, etc. (individually and collectively referenced by reference number 728). For example, communication interface 724 may allow computer system 700 to communicate with remote devices 728 over communications path 726, which may be wired and/or wireless, and which may include any combination of LANs, WANs, the Internet, etc. Control logic and/or data may be transmitted to and from computer system 700 via communication path 726.

In an embodiment, a tangible, non-transitory apparatus or article of manufacture comprising a tangible, non-transitory computer useable or readable medium having control logic (software) stored thereon is also referred to herein as a computer program product or program storage device. This includes, but is not limited to, computer system 700, main memory 708, secondary memory 710, and removable storage units 718 and 722, as well as tangible articles of manufacture embodying any combination of the foregoing. Such control logic, when executed by one or more data processing devices (such as computer system 700), causes such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 7. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A method, comprising:
deriving, by one or more computing devices, a query point cloud from a sweep of a light detection and ranging (lidar) sensor device of a vehicle and a reference point cloud from a high-definition (HD) map;
extracting, by the one or more computing devices, a first set of features from the query point cloud and a second set of features from the reference point cloud
determining, by the one or more computing devices, a coarse alignment based on a plurality of matches between the first set of features from the query point cloud and the second set of features from the reference point cloud; and
estimating, by the one or more computing devices, a position-orientation pose of the vehicle by refining the coarse alignment using an iterative closest point (ICP) algorithm.

2. The method of claim 1, wherein the deriving the reference point cloud from the HD map further comprises:
selecting, by the one or more computing devices and based on geolocation data obtained from one or more geolocation sensor devices of the vehicle at commencement of an activation sequence of the vehicle, a map tile comprising a predefined geographical area that includes an initial location of the vehicle from a plurality of map tiles in the HD map; and
obtaining, by the one or more computing devices, the reference point cloud from the selected map tile in the HD map.

3. The method of claim 1, further comprising:
downsampling, by the one or more computing devices, voxels in the query point cloud and the reference point cloud; and
deriving, by the one or more computing devices, a surface normal for each of the query point cloud and the reference point cloud.

4. The method of claim 1, wherein the extracting the first set of features from the query point cloud and the second set of features from the reference point cloud further comprises:
deriving, by the one or more computing devices, at least one fast point feature histogram (FPFH) descriptor for every point in the query point cloud and the reference point cloud.

5. The method of claim 1, further comprising:
generating, by the one or more computing devices, the plurality of matches between the first set of features from the query point cloud and the second set of features from the reference point cloud by pairing each point in the query point cloud with a closest neighboring point in the reference point cloud.

6. The method of claim 1, wherein the determining the coarse alignment further comprises:
generating, by the one or more computing devices, a plurality of solutions by applying a predetermined number of distinct graduated non-convexity (GNC) optimizations with uniformly sampled initial vehicle headings to the plurality of matches between the first set of features from the query point cloud and the second set of features from the reference point cloud;
determining, by the one or more computing devices, a number of inlier feature matches for each solution in the plurality of solutions; and
identifying, by the one or more computing devices, the solution with the highest number of inlier feature matches as the coarse alignment.

7. The method of claim 6, wherein each inlier feature match comprises a feature correspondence pair having a first point in the query point cloud and a second point in the reference point cloud that are within a predetermined distance threshold of each other.

8. A non-transitory computer readable medium storing instructions that, when executed by one or more processors, causes the one or more processors to perform operations comprising:
deriving a query point cloud from a sweep of a light detection and ranging (lidar) sensor device of a vehicle and a reference point cloud from a high-definition (HD) map;
extracting a first set of features from the query point cloud and a second set of features from the reference point cloud;
determining a coarse alignment based on a plurality of matches between the first set of features from the query point cloud and the second set of features from the reference point cloud; and
estimating a position-orientation pose of the vehicle by refining the coarse alignment using an iterative closest point (ICP) algorithm.

9. The non-transitory computer readable medium of claim 8, wherein the operations further comprise:
selecting, based on geolocation data obtained from one or more geolocation sensor devices of the vehicle at commencement of an activation sequence of the vehicle, a map tile comprising a predefined geographical area that includes an initial location of the vehicle from a plurality of map tiles in the HD map; and
obtaining the reference point cloud from the selected map tile in the HD map.

10. The non-transitory computer-readable medium of claim 8, wherein the operations further comprise:
downsampling voxels in the query point cloud and the reference point cloud; and
deriving a surface normal for each of the query point cloud and the reference point cloud.

11. The non-transitory computer-readable medium of claim 8, wherein the extracting the first set of features from the query point cloud and the second set of features from the reference point cloud further comprises:
deriving at least one fast point feature histogram (FPFH) descriptor for every point in the query point cloud and the reference point cloud.

12. The non-transitory computer-readable medium of claim 8, wherein the operations further comprise:
generating the plurality of matches between the first set of features from the query point cloud and the second set of features from the reference point cloud by pairing each point in the query point cloud with a closest neighboring point in the reference point cloud.

13. The non-transitory computer-readable medium of claim 8, wherein the determining the coarse alignment further comprises:
generating a plurality of solutions by applying a predetermined number of distinct graduated non-convexity (GNC) optimizations with uniformly sampled initial vehicle headings to the plurality of matches between the first set of features from the query point cloud and the second set of features from the reference point cloud;
determining a number of inlier feature matches for each solution in the plurality of solutions; and
identifying the solution with the highest number of inlier feature matches as the coarse alignment.

14. The non-transitory computer-readable medium of claim 13, wherein each inlier feature match comprises a feature correspondence pair having a first point in the query point cloud and a second point in the reference point cloud that are within a predetermined distance threshold of each other.

15. A system, comprising:
one or more processors; and
a memory communicatively coupled to the one or more processors, wherein the memory stores instructions that, when executed by the one or more processors, cause the one or more processors to perform operations comprising:
deriving a query point cloud from a sweep of a light detection and ranging (lidar) sensor device of a vehicle and a reference point cloud from a high-definition (HD) map;
extracting a first set of features from the query point cloud and a second set of features from the reference point cloud
determining a coarse alignment based on a plurality of matches between the first set of features from the query point cloud and the second set of features from the reference point cloud; and
estimating a position-orientation pose of the vehicle by refining the coarse alignment using an iterative closest point (ICP) algorithm.

16. The system of claim 15, wherein the operations further comprise:
selecting, based on geolocation data obtained from one or more geolocation sensor devices of the vehicle at commencement of an activation sequence of the vehicle, a map tile comprising a predefined geographical area that includes an initial location of the vehicle from a plurality of map tiles in the HD map; and
obtaining the reference point cloud from the selected map tile in the HD map.

17. The system of claim 15, wherein the operations further comprise:
downsampling voxels in the query point cloud and the reference point cloud; and
deriving a surface normal for each of the query point cloud and the reference point cloud.

18. The system of claim 15, wherein the extracting the first set of features from the query point cloud and the second set of features from the reference point cloud further comprises:
deriving at least one fast point feature histogram (FPFH) descriptor for every point in the query point cloud and the reference point cloud.

19. The system of claim 15, wherein the operations further comprise:
generating the plurality of matches between the first set of features from the query point cloud and the second set of features from the reference point cloud by pairing each point in the query point cloud with a closest neighboring point in the reference point cloud.

20. The system of claim 15, wherein the determining the coarse alignment further comprises:
generating a plurality of solutions by applying a predetermined number of distinct graduated non-convexity (GNC) optimizations with uniformly sampled initial vehicle headings to the plurality of matches between the first set of features from the query point cloud and the second set of features from the reference point cloud;
determining a number of inlier feature matches for each solution in the plurality of solutions, wherein each inlier feature match comprises a feature correspondence pair having a first point in the query point cloud and a second point in the reference point cloud that are within a predetermined distance threshold of each other; and
identifying the solution with the highest number of inlier feature matches as the coarse alignment.
